(19) United States
(12) Patent Application Publication
(10) Pub. No.: US 2012/0130549 A1
(43) Pub. Date: May 24, 2012

(54) PLANT FOR STORING AND SUPPLYING COMPRESSED GAS

(75) Inventors: Kjetil Fjalestad, Skien (NO); Leif Kåre Grønstad, Sannidal (NO); Øyvind Kaasa, Ulefoss (NO); Torgeir Nakken, Porsgrunn (NO); Pål Kittilsen, Trondheim (NO)

(73) Assignee: NEL HYDROGEN AS, Notodden (NO)

(21) Appl. No.: 13/148,785

(22) PCT Filed: Feb. 11, 2010
(86) PCT No.: PCT/NO2010/000051

§ 371 Date: Feb. 10, 2012

(30) Foreign Application Priority Data
Feb. 11, 2009 (NO) 2009 0660

(51) Int. Cl. G05D 7/00

(52) U.S. Cl. 700/282

(57) ABSTRACT

A plant for storing and supplying compressed gas comprises a storage tank (1) for gas, at least one pressurization tank (2) for gas and a buffer tank (3) for a pressure support fluid to be filled into or evacuated from lower portions of the storage and pressurization tanks. The lower portions of the storage and pressurization tanks are communicating with the buffer tank via fluid flow lines (4, 5) to fill fluid during supplying from and pressurizing gas in the plant, and a flow line (7) for evacuating fluid during refilling of the pressurization tank. According to a preferred embodiment the lower portions of the storage and pressurization tanks are communicating with one another via a fluid flow line (6) to exchange fluid between the storage and pressurization tank, whereas gas being pressurized in the pressurization tank is moved into the storage tank via a gas flow line (8) communicating the pressurization and storage tanks with one another, the gas flow line being situated between upper portions of the pressurization and storage tanks.

The present invention relates to a plant for storing and supplying compressed gas such as compressed hydrogen gas from various filling plants and the like. The present invention also relates to a method in relation to such a plant.

One common alternative for a fuel filling station is to store and supply compressed hydrogen gas. Normally, this is effected by means of storing compressed hydrogen in one or more stationary storage tanks, and the vehicles' fuel tanks are then filled by decanting using pressure difference forces, also called cascade filling. This solution is used by a great number of hydrogen fuel stations.

The use of cascade filling requires some overpressure in the storage tanks and, when the filling is completed, the pressure in the storage tank is equal or higher than the pressure in the vehicle tank. Thus, there will always be significant amounts of hydrogen left in the storage tanks that cannot be utilized. The typically percentages for storage efficiencies are 30-60%, i.e. the relative amount of stored gas to be exploited for filing in cascade-based filling stations. This has several drawbacks:
1. This unexploited hydrogen gas causes an extra safety risk, because there is at all times a need to store significantly more hydrogen than can be transferred to the vehicles.
2. There is an extra cost related to this excess of storage capacity needed.
3 Extra space is required.
4. The dimensioning of the filling station is a difficult and non-precise task, as the storage pressure, and thus the availability to refill vehicles, varies as function of the filling frequency and quantities.

Based on these facts, it is obviously a need of a plant for storing and supplying compressed gas having improved storage efficiency and, thus, provides for smaller gas storage tanks, for instance.

According to a first aspect the of present invention, a plant for compressing gas is disclosed, including at least one pressurization tanks for gas. The plant further is comprising a buffer tank for a pressure support fluid to be filled into or evacuated from a lower portion of the respective pressurization tank, and the lower portion of the pressurization tank is communicating with the buffer tank via a fluid flow line to fill and evacuate fluid during pressurization and refilling, respectively.

According to a second aspect the of present invention, a plant for storing and supplying compressed gas is disclosed. The plant is comprising a storage tank for gas, at least one pressurization tank for gas and a buffer tank for a pressure support fluid to be filled into or evacuated from lower portions of the storage and pressurization tanks, and the lower portions of the storage and pressurization tanks are communicating with the buffer tank via fluid flow lines to fill fluid during supplying from and pressurizing gas in the plant, and a flow line for evacuating fluid during refilling of the pressurization tank.

According to a third aspect of the present invention, a plant for storing compressed gas is disclosed, including a storage tank for gas. The plant further is comprising a buffer tank for a pressure support fluid to be filled into or evacuated from a lower portion of the storage tank, and the lower portion of the storage tank is communicating with the buffer tank via a fluid flow line to fill and evacuate fluid during supplying gas from the plant and refilling gas to the plant, respectively.

According to another aspect of the invention, there is disclosed a method in a plant for compressing gas, the plant including at least one pressurization tanks for gas, and a buffer tank for a pressure support fluid, wherein a lower portion of the pressurization tank is communicating with the buffer tank via a fluid flow line, the method comprising: filling or evacuating fluid into or from the lower portion of the respective pressurization tank via the fluid flow line during pressurization and refilling, respectively.

According to yet another aspect of the invention, there is disclosed a method in a plant for storing and supplying compressed gas, the plant including a storage tank for gas, at least one pressurization tank for gas, and a buffer tank for a pressure support fluid, wherein lower portions of the storage and pressurization tanks are communicating with the buffer tank via fluid flow lines, and wherein a lower portion of the respective pressurization tank is communicating with the buffer tank via a flow line, the method comprising: filling fluid into lower portions of the storage and pressurization tanks via the fluid flow lines during supplying from and pressurizing gas in the plant; and evacuating fluid from the lower portion of the respective pressurization tank via the flow line during refilling of the pressurization tank.

The lower portions of the storage and pressurization tanks can favourably communicate with one another via a fluid flow line to exchange fluid between the storage and pressurization tank, whereas the gas being pressurized in the pressurization tank can be moved into the storage tank via a gas flow line communicating the pressurization and storage tanks with one another, the gas flow line being situated between upper portions of the pressurization and storage tanks.

Thus, and as mentioned above, is specified a concept using fluid as a pressure support during supplying and pressurization gas as well as during moving gas from the pressurization tank into the storage tank. With this solution it is possible to get almost 100% storage efficiency. In addition, as to be shown, it is possible to combine the pressure support feature with an alternative compression technology. The advantages are need for less storage size on the filling plants and more (energy) efficient gas compression.

In addition, this compression technology, using a fluid pumps rather than traditional mechanical gas compressors, has an improved robustness, making the compression technology in far better accordance with the requirements for filling station applications.

Yet another advantage of using the specified invention, is the ease of measuring the amount of gas supplied to the end-user. The variation in amount of pressure support fluid in the storage tank is directly linked to the amout of gas supplied to the end user, and expensive mass flow meters can be replaced by simple, robust and inexpensive methods of utilizing a mass balances on the storage tank, possible in combination with monitoring the flow through the fluid pump.

Other favourable embodiments of the present invention are to be understood from the dependent claims and the discussion below. Features of the dependent claims may also apply to the above-mentioned methods.

Now, the present invention is to be described in detail with reference to the drawings, in which:

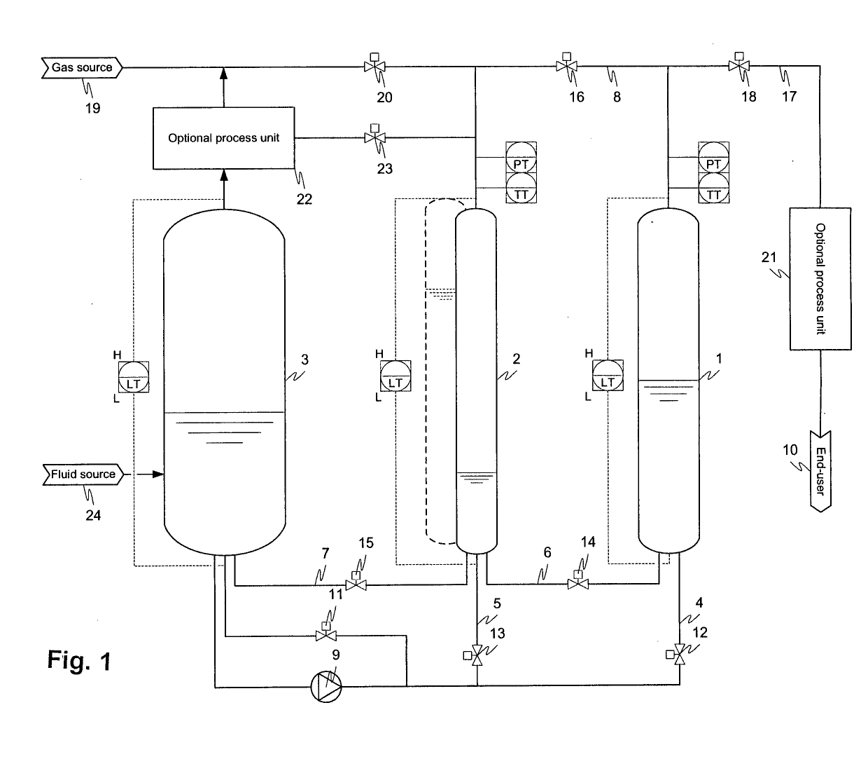

FIG. 1 illustrates a preferred embodiment including a storage tank, one or more pressurization tanks, and a buffer tank.

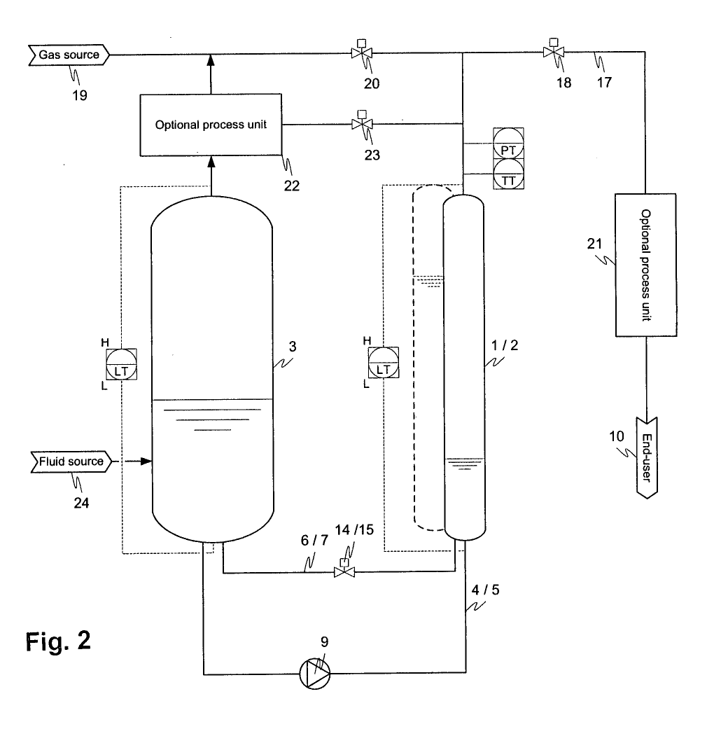

FIG. 2 illustrates an embodiment including either a storage tank or one or more pressurization tanks, and a buffer tank.

The pressure support concept according to the present invention is envisaged grouped into three process units, as illustrated in FIG. 1. Although presented in the form of a tank for storing and supplying compressed gas such as hydrogen in fuel filling stations, it is to be understood that this shall only be interpreted in an illustrative and, thus, not restrictive manner. The invention can be used in connection with other gases than hydrogen such as natural gas or propane, for instance, and even non-gaseous fluids having a lower density than the fluid is also applicable as long as the fluid and the product fluid are non-miscible. The potential loss of product through diffusion or evaporation can be reduced by physical means on the interphase between the two fluids. The description is focusing on use of water as the fluid and hydrogen as the product fluid but this is not involving a restriction neither shall the reference to fuel filling stations, as the latter can be replaced by any facility in need of such pressure support concept.

1. A storage tank 1 for hydrogen. This unit contains of a vertical raised container with water in the lower part and hydrogen in the upper part. Hydrogen from this container is to be filled into vehicle tanks. The pressure is set to the maximal end-pressure of vehicle filling, e.g. typical 875 bar for a 700-bar system. The pressure is kept constant by adjusting the water level within the container. A filling pump 9 is used for pumping water into the container from a water buffer tank 3, see below. Further, hydrogen is filled into vehicles by means of a supply line 17 including at least one filling supply valve 18.
2. At least one pressurization tank 2 for hydrogen, possible supplementary tanks are indicated by dotted line. This unit is similar to the vertical raised container mentioned above to be the storage tank 1. The volume of each of the pressurization tanks is normally smaller than the storage tank and each of these tanks along with the storage tank are supplied from an external hydrogen source 19. A source valve 20 is included in a hydrogen line between the external source and the respective pressurization tanks. The operation pressure is between the pressure of the storage tank and hydrogen source, respectively. A pressurization tank pump 9 is used to fill water from the buffer tank 3. The pump can be the same as the pump described in paragraph 1, or be a separate pump to serve the pressurization tank independently of the storage tank. Several pressurization tanks can be combined to allow for operation in different states:
a. Pressurization state in which the mass of hydrogen in the pressurization tank 2 is constant, and the water level is raised to increase the pressure.
b. Exchange state in which hydrogen from the pressurization tank is exchanged with water from the storage tank 1.
c. Refilling state in which the hydrogen pressure is constant and the water is evacuated through a flow line 7 to the buffer tank 3, and the water level is low-ered to import hydrogen from the source 19.
   3. A water buffer tank 3. This unit is a buffer for the water used in the storage and pressurization tanks 2. The pressure is relatively low. Because dissolved hydrogen may evaporate from the depressurized water, there is need for hydrogen handling by an optional unit 22 with the possible recycle of vaporized hydrogen through a supply valve 23 or by venting the vaporized gas.

Exemplary pressure values for the storage tank 1, pressurization tank 2, buffer tank 3, and vehicle tank 10 are typically 875 bar, 30-875 bar, 1-30 bar, and 50-875 bar, respectively.

The process units mentioned above are operated almost independently of each other with base layer, PLC controllers and autonomous mechanical equipment, e.g. check valves, not illustrated, to maintain a desired pressure or sequence. The normal operation of the process can be groped as follows, see also FIG. 1. Note there are two slightly different modes of operating the compressor cycle, depending on how hydrogen and water is exchanged between the pressurization and storage tanks:

1. Vehicle Filling.
a. A vehicle tank 10 is attached to the storage tank 1 and the filling valve 18 is opened, thereby allowing hydrogen to flow from the storage tank having higher pressure to the vehicle tank having lower pressure. Then, the pressure in the storage tank starts to decrease but a pressure controller, not illustrated, is initiating a flow of water into the storage tank to keep the pressure at its set point. The desired amount of water is pumped from the buffer tank 3 into the storage tank using the filling pump 9 and the optional filling pump control valve 11.

2. Compression Cycle.
a. Compressing state. At the start of this phase, the pressurization tank 2 is filled completely with hydrogen having the pressure equal to the source 19, e.g. about 30 bar. All gas source valves and sink valves 16, 20, 23 are closed. The control system starts pumping water into the pressurization tank via the water pump 9. If the process is made with only one pressurization tank, water is taken from the buffer tank 3. If two or more pressurization tanks 2 are present, it is possible to take water from one of these other pressurization tanks being in the refilling state, see below. Using another pressurization tank can reduce the boil-off of hydrogen in the buffer tank. During the compressing state, the pressure increases correspondingly to the decrease in gas volume. From this point there are different options on further progress according to an overpressure exchange type of algorithm, or a gravity or pump exhange algorithm:
   1. Overpressure exchange. The pressure elevation progress until the pressurization tank pressure reaches the storage tank pressure. At this point the control system or a check valve opens for gas flow 16 and hydrogen is transferred from the pressurization to the storage tank. Water is still pumped into the tank until the pressurization tank level or the pressure in the storage tank reaches an upper limit, i.e. higher than the setpoint of the storage tank. The cycle then continues with the refilling state.
   ii. Gravity or pump exchange. The pressure elevation progress until: either 1) the pressurization tank pressure reaches the storage tank pressure, if this is lower than the setpoint, at this point the control system or a check valve opens for gas flow 16 and hydrogen is transferred from the pressurization to storage tank; or 2) the pressurization tank pressure reaches the setpoint of the storage pressure. In the latter case the supply from the water pump is stopped, by closing a supply valve 13, and for a gravity operated process, in which the storage tank is elevated with respect to the pressurization tank, both the hydrogen and water valves 16, 14 between the pressurization tank and storage tank are opened to let water run from the storage tank into the pressurization tank in the lower sections of the tanks, flow line 6, and hydrogen flowing from the pressurization tank to the storage tank in the gas flow line 8. In a pump exchange process, a pump, possibly the pump 9 in a modified process configuration, must ensure the water flow from the storage tank 1 to the pressurization tank 2. Both case 1) and 2) progress until the water level in the pressurization tank is at its highest setpoint, e.g. 99%, with the state change to the refilling state. This exchange of hydrogen and water will ensure a minimal loss of the dissolved hydrogen in the storage tank water with a minimum use of power.
b. Refilling state. At the onset of this state, the pressurization tank 2 is almost filled with water at the pressure of the storage tank 1, e.g. about 875 bar. The next step is to exchange water with “fresh” hydrogen for another compression cycle. The flow line from the pressurization tank to the buffer tank 3 is opened, alternatively to the path to another pressurization tank, discharging water to depressurize the tank. The pressure is decreasing as the water level lowers. As the pressure decreases, hydrogen evaporates from the water, but mainly inside the pressurization tank. Thus, this hydrogen can be recompressed again in the next cycle and is not “lost” to the buffer tank 3. At some point, such as at a certain water level, the pressure in the pressurization tank equals the pressure of the hydrogen source 19. The control system, or a check valve, then opens a supply valve 20 from the source into the pressurization tank. When the water level is further decreased, hydrogen from the source is filling the pressurization tank. This progress until the water level is at the minimum and, thus, the compression cycle progress to the next state in case of overpressure mode, or the compression is repeated by jumping to step a, otherwise.
c. Exchange state. This state is for the overpressure algorithm, 2.a.i only. At the finalization of the compressing state, the pressure in the storage tank 1 was allowed to increase. Now, it is time to lower the pressure by transferring water from the storage tank to the pressurization tank 2. This occurs only if the pressure in the storage tank is above the setpoint. By moving water from the storage tank to the pressurization tank, the evaporated hydrogen is recompressed and not lost to the buffer tank. The transfer is enabled by using a flow line 6 by opening the supply valve from the storage to the pressurization tank 14 until the pressure in the storage tank drops to a lower desired pressure. After this step, the system is ready to repeat the compression cycle by returning to step a.

Controlling the water pressure support filling process is carried out by using a combination of process control elements, such as PI controllers, not illustrated, PLC algorithms and autonomous mechanical components such as check valves. The PI-controllers are always active and work in parallel with the different steps initiated by the PLC.

Now, a more detailed explanation is to be given of components included in the plants according to the present invention. The lower portions of the storage and pressurization tanks 1, 2 are communicating with one another via a fluid flow line 6 to exchange fluid between the storage and pressurization tank, whereas the gas being pressurized in the pressurization tank is moved into the storage tank via a gas flow line 8 communicating the pressurization and storage tanks with one another, the gas flow line being situated between upper portions of the pressurization and storage tanks. The exchange of gas and fluid can occur either simultaneously by using a pump or gravitational forces to move the fluid from the storage to the pressurization tank, or by sequenctional operation for which a provided overpressure in the storage tank in the first part of the sequence enables the transfer of fluid from the storage tank to the pressurization tank in the second part of the sequence.

The fluid flow line 4 for the storage tank 1 is formed with at least one filling pump 9 used to fill fluid from the buffer tank 3 into the storage tank 1 when supplying gas from the plant to an end-user 10 and a storage tank shut-off valve 12 used when pressurizing the gas contained in the pressurization tank 2 using fluid from the buffer tank. The fluid flow line 5 for the pressurization tank 2 is having at least one pressurization pump 9 used to fill fluid from the buffer tank 3 into the pressurization tank when pressurizing the gas contained in the pressurization tank, and a pressurization tank shut-off valve 13 used when gas contained in the storage tank 1 is to be filled to an and-user using fluid from the buffer tank. The fluid filling rate into the storage and pressurization tanks can be controlled by a filling pump control valve 11 or by a direct control of the filling pump rate, not excluding other alternative fluid rate controlling mechanisms. It is understood that both of the flow lines 4, 5 can be fed using the same pump 9. A fluid outlet line 7 from the pressurization tank 2 and a gas outlet line 17 from the storage tank 1 is equipped with a fixed or variable restriction supply valve 15, 18, respectively.

Gas is filled into the pressurization tank 2 from an external gas source 19 via an external gas source supply valve 20, or directly into the storage tank from an external high pressure gas source via an external gas source supply valve, not illusterated. Fluid is filled into the buffer tank 3 from an external fluid source 24 to compensate for any fluid loss from the plant.

The fluid level can be monitored by high and low level detectors to prevent fluid from entering gas flow lines. Further, the fluid level, gas temperature and tank pressure can be measured and applied with the tank volume for calculating or, alternatively, the pump strokes can be measured and applied for calculating the mass of gas either filled to the end-user 10 or compressed during each cycle. The fluid and/or gas can be separated by suitable means to reduce any exchange of molecules between the fluids. Non of these feature are shown in the drawings.

The gas supplied to the end-user 10 is processed, e.g in a unit 21, thereby enabling the gas to be dried, cleaned, cooled and the like. The pressure in the buffer tank 3 is measured and controlled to optimize the energy consumption for filling and/or compression. Further, any gas or fluid discharged from the buffer tank 3 is processed, e.g. dried, cleaned, etc., before being released or recycled into the plant through a suitable processing unit 22 via a supply valve 23. The fluid can be heated or cooled to obtain the desired storage and pressurization gas temperature and fluid temperature as to optimize energy consumption and prevent freezing or evaporation, not illustrated.

The operation of the plant is automated by any combination of at least one automatic control system, e.g. a programmable logic controller, and the use of autonomous mechanical units, such as check valves or the like.

1. A plant for compressing gas including at least one pressurization tanks for gas, characterized in that the plant further is comprising a buffer tank for a pressure support fluid to be filled into or evacuated from a lower portion of the respective pressurization tank, and in that the lower portion of the pressurization tank is communicating with the buffer tank via a fluid flow line to fill and evacuate fluid during pressurization and refilling, respectively.

2. A plant for storing and supplying compressed gas, characterized in that the plant is comprising a storage tank for gas, at least one pressurization tank for gas and a buffer tank for a pressure support fluid to be filled into or evacuated from lower portions of the storage and pressurization tanks, and in that the lower portions of the storage and pressurization tanks are communicating with the buffer tank via fluid flow lines to fill fluid during supplying from and pressurizing gas in the plant, and a flow line for evacuating fluid during refilling of the pressurization tank.

3. A plant for storing compressed gas including a storage tank for gas, characterized in that the plant further is comprising a buffer tank for a pressure support fluid to be filled into or evacuated from a lower portion of the storage tank, and in that the lower portion of the storage tank is communicating with the buffer tank via a fluid flow line to fill and evacuate fluid during supplying gas from the plant and refilling gas to the plant, respectively.

4. A plant according to claim 1, characterized in that the lower portions of the storage and pressurization tanks are communicating with one another via a fluid flow line to exchange fluid between the storage and pressurization tank, whereas the gas being pressurized in the pressurization tank is moved into the storage tank via a gas flow line communicating the pressurization and storage tanks with one another, the gas flow line being situated between upper portions of the pressurization and storage tanks.

5. A plant according to the claim 4, characterized in that the exchange of gas and fluid is occurring either simultaneously by using a pump or gravitational forces to move the fluid from the storage to the pressurization tank, or by sequential operation for which a provided overpressure in the storage tank in the first part of the sequence enables the transfer of fluid from the storage tank to the pressurization tank in the second part of the sequence.

6. A plant according to claim 1, characterized in that the fluid flow line for the storage tank is provided with at least one or filling pump used to fill fluid from the buffer tank into the storage tank when supplying gas from the plant to an end-user and a storage tank shut-off valve used when pressurizing the gas contained in the pressurization tank using fluid from the buffer tank.

7. A plant according to claim 1, characterized in that the fluid flow line for the pressurization tank is provided with at least one more pressurization pump used to fill fluid from the buffer tank into the pressurization tank when pressurizing the gas contained in the pressurization tank, and a pressurization tank shut-off valve used when gas contained in the storage tank is to be filled to an and-user using fluid from the buffer tank.

8. A plant according to claim 6, characterized in that the fluid filling rate into the storage and pressurization tanks is controlled by a filling pump control valve, or by a direct control of the filling pump rate, or by other alternative fluid rate controlling mechanisms.

9. A plant according to claim 1, characterized in that the fluid flow line between the storage and pressurization tanks is equipped with a fixed or variable restriction supply valve, and the gas flow line between the pressurization and storage tank is provided with a fixed or variable restriction supply valve used when exchanging fluid and moving pressurized gas between the storage and pressurization tanks, respectively.

10. A plant according to claim 1, characterized in that the fluid outlet line from the pressurization tank is formed with a fixed or variable restriction supply valve.

11. A plant according to claim 1, characterized in that a gas outlet line from the storage tank is equipped with a fixed or variable restriction supply valve.

12. A plant according to claim 1, characterized in that gas is filled into the pressurization tank from an external gas source via an external gas source supply valve.

13. A plant according to claim 1, characterized in that gas is filled directly into the storage tank from an external high pressure gas source via an external gas source supply valve.

14. A plant according to claim 1, characterized in that fluid is filled into the buffer tank from an external fluid source to compensate for any fluid loss from the plant.

15. A plant according to claim 1, characterized in that the fluid level is monitored by high and low level detectors to prevent fluid from entering gas flow lines.

16. A plant according to claim 1, characterized in that the fluid level, gas temperature and tank pressure are measured and applied with the tank volume for calculating the mass of gas either filled to the end-user or compressed during each cycle.

17. A plant according to claim 1, characterized in that the pump strokes are measured and applied for calculating the mass of gas either filled to the end-user or compressed during each cycle.

18. A plant according to claim 1, characterized in that the fluid and gas is separated by suitable means to reduce any exchange of molecules between the fluids.

19. A plant according to claim 1, characterized in that the gas supplied to the end-user is processed, e.g in a unit as to enable drying, cleaning, cooling and the like.

20. A plant according to claim 1, characterized in that the pressure in the buffer tank is measured and controlled to optimize the energy consumption for filling and/or compression.

21. A plant according to claim 1, characterized in that any gas or fluid discharged from the buffer tank is processed before being released or recycled into the plant through a processing unit via a supply valve.

22. A plant according to claim 1, characterized in that fluid is heated or cooled to obtain the desired storage and pressurization gas temperature and fluid temperature as to optimize energy consumption and prevent freezing or evaporation.

23. A plant according to claim 1, characterized in that the operation of the plant is automated by any combination of at least one automatic control system and the use of autonomous mechanical units.

24. A plant according to claim 1, further comprising a storage tank for gas, wherein a lower portion of the storage tank is in communication or connection with the buffer tank via a fluid flow line to fill fluid during supplying from the plant.

25. A method in a plant for compressing gas, the plant including at least one pressurization tanks for gas, and a buffer tank for a pressure support fluid, wherein a lower portion of the pressurization tank is communicating with the buffer tank via a fluid flow line, the method comprising:
filling or evacuating fluid into or from the lower portion of the respective pressurization tank via the fluid flow line during pressurization and refilling, respectively.

26. A method in a plant for storing and supplying compressed gas, the plant including a storage tank for gas, at least one pressurization tank for gas, and a buffer tank for a pressure support fluid, wherein lower portions of the storage and pressurization tanks are communicating with the buffer tank via fluid flow lines, and wherein a lower portion of the respective pressurization tank is communicating with the buffer tank via a flow line, the method comprising:
filling fluid into lower portions of the storage and pressurization tanks via the fluid flow lines during supplying from and pressurizing gas in the plant; and
evacuating fluid from the lower portion of the respective pressurization tank via the flow line during refilling of the pressurization tank.
